(19) United States
(12) Patent Application Publication
(10) Pub. No.: US 2018/0302811 A1
(43) Pub. Date: Oct. 18, 2018

(54) GATHERING AND STORING OF DATA ACROSS MULTIPLE SYSTEMS AND NODES OF A WIRELESS COMMUNICATION NETWORK

(71) Applicant: T-Mobile USA, Inc., Bellevue, WA (US)

(72) Inventors: Kendall C. Bush, Bellevue, WA (US); Florendo Atienza, Bellevue, WA (US); Suchit Satpathy, Hackettstown, NJ (US); Nicolae Vasu, Bellevue, WA (US)

(21) Appl. No.: 15/718,326

(22) Filed: Sep. 28, 2017

Related U.S. Application Data
(60) Provisional application No. 62/486,759, filed on Apr. 18, 2017.

(51) Int. Cl. H04W 24/08; G06F 17/30

(52) U.S. Cl. CPC H04W 24/08; G06F 17/30575

(57) ABSTRACT

A wireless communication network includes an asset database that gathers and stores data across multiple systems and a plurality of nodes of the wireless communication network. The asset database receives data from at least two nodes of the plurality of nodes. The at least two network nodes generally do not communicate the data with each other. One or more asset nodes of the wireless communication network are identified. The one or more asset nodes are provisioned based at least in part on the received data. The asset database may use the data to generate reports, generate alerts, proactively audit nodes of the wireless communication network and/or perform a self-healing operation at one or more nodes.

### CROSS REFERENCE TO RELATED APPLICATIONS

This disclosure claims priority to U.S. Provisional Patent Application No. 62/486,759, filed Apr. 18, 2017, which is incorporated herein by reference.

### BACKGROUND

In recent years, telecommunication devices have advanced from offering simple voice calling services within wireless communication networks to providing users with many new features. Telecommunication devices now provide messaging services such as email, text messaging, and instant messaging; data services such as Internet browsing; media services such as storing and playing a library of favorite songs; location services; and many others. Thus, telecommunication devices, referred to herein as user devices or mobile devices, are often used in multiple contexts. In addition to the new features provided by the telecommunication devices, users of such telecommunication devices have greatly increased. Such an increase in users is only expected to continue and in fact, it is expected that there could be a growth rate of twenty times more users in the next few years alone.

It has been determined that a big difference in performance of wireless communication networks can be achieved by moving users closer to base stations that handle the traffic within the wireless communication networks. Generally, the base stations control telecommunication device traffic within a macro cell. Those macro cells usually include a single base station. The closer a user is to the base station, the more efficient the service provided to the user. For example, a user close to the edge of the macro cell may achieve only five megabits (Mb) per second of performance with a telecommunication device, while a user closer to the base station may achieve a 50 Mb per second performance with a telecommunication device.

To help address such performance issues within wireless networks, heterogeneous networks have been created. In such heterogeneous networks, the macro cells are divided into smaller cells generally referred to as femtocells, pico cells, micro cells, or the like. Each macro cell is still controlled by a high-power node or base station, while the femtocells are controlled by lower power nodes or access points. The access points control traffic of telecommunication devices within their corresponding femtocells.

Generally, in wireless communication networks, service is provided to users by complex business logic and a very distributed network architecture. Thus, troubleshooting of the wireless communication networks is complex and there may be data discrepancy and state discrepancy across the various systems of the wireless communication networks. For example, in order to troubleshoot a wireless communication network, technicians may need to log into different nodes of the wireless communication network to determine what the problem is. Based on the capacity and node, some nodes may be receptive to such a log in, while other nodes may not be receptive. Limitations in capacity and practicality may result in it not being possible to go to different systems of the wireless communication network and troubleshoot the nodes in real time.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 schematically illustrates a wireless communication network, in accordance with a configuration.

FIG. 2 schematically illustrates a macro cell of the wireless network of FIG. 1 divided into a plurality of femtocells, in accordance with a configuration.

FIG. 3 schematically illustrates an asset database operationally coupled to nodes of the wireless communication networks of FIGS. 1 and 2, in accordance with a configuration.

FIG. 4 is a flowchart illustrating an example method for gathering data across multiple systems and nodes of the wireless communication networks of FIGS. 1 and 2, in accordance with a configuration.

FIG. 5 illustrates a component level view of a server configured for use in the arrangements of FIGS. 1-3 to provide various services of the wireless communication network of FIGS. 1-3.

### DETAILED DESCRIPTION

Described herein are techniques and an architecture for gathering and storing of data across multiple systems and nodes of a wireless communication network.

In a configuration, a central database or asset database within the wireless communication network is operationally coupled to various nodes of the wireless communication network. The nodes generally provide services and operational functions within the wireless communication network. Additionally, the wireless communication network may be divided into multiple subnetworks and thus, some nodes may be repetitive, e.g., each of the various subnetworks may each include a particular node. The wireless communication network may be divided into multiple macro cells and the macro cells may be divided into small cells, e.g., femto cells, pico cells, micro cells, or the like. The multiple macro cells and small cells may be organized into multiple subnetworks that make up the wireless communication network. For example, the wireless communication network may be a national network and thus, the wireless communication network may be divided into four regional subnetworks, where each regional subnetwork includes multiple nodes and multiple macro cells that may be divided into small cells.

In a configuration, the central database may be coupled to all of the various nodes across the wireless communication network. For example, the wireless communication network may include a security gateway node, a small cell gateway node, an authentication accounting authorization node, a service management platform node, a customer account and billing information node, and a provision agent node. In the example where the wireless communication network is divided into four subnetworks, each of the subnetworks may include one or more of each of the nodes.

The asset database is operationally coupled to the various nodes and thus, may pull data from the various nodes by synchronizing with the nodes. The data may be pulled periodically, e.g., in a range of every 30 minutes to one hour. In a configuration, the data may be pulled once a day.

Since the wireless communication network may divided into subnetworks, the central database may synchronize and pull data from each of the nodes in the subnetworks. The central database may then organize and synchronize the data pulled based upon the node type. For example, the central database may organize and synchronize the data pulled from each of the security gateway nodes. Additionally, the central database may normalize the gathered data with respect to at least time since the subnetworks may be located in different time zones. Based at least in part on the data, one or more asset nodes or access point nodes for macro cells and/or small cells may be provisioned. Additionally, based at least in part on the data, alarms may be generated for one or more nodes, reports may be generated for one or more nodes, audits may be performed for one or more nodes and/or self-healing operations may be performed for one or more nodes.

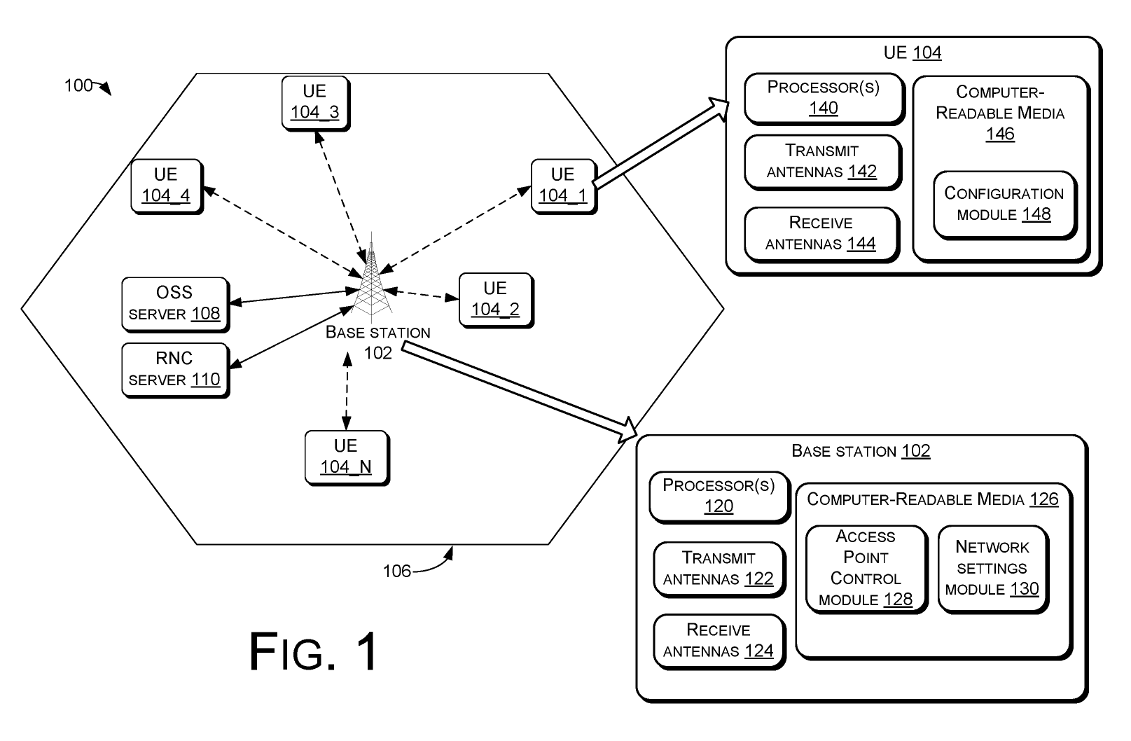

FIG. 1 illustrates a wireless communication network 100 (also referred to herein as network 100). The network 100 comprises a base station (BS) 102 communicatively coupled to a plurality of user devices, referred to as UEs 104_1, 104_2, . . . , 104_N, where N is an appropriate integer. The BS 102 serves UEs 104 located within a geographical area, e.g., within a macro cell 106. FIG. 1 illustrates the macro cell 106 to be hexagonal in shape, although other shapes of the macro cell 106 may also be possible. In general, the network 10 comprises a plurality of macro cells 106, with each macro cell 106 including one or more BSs 102.

In an embodiment, the UEs 104_1, . . . , 104_N may comprise any appropriate devices for communicating over a wireless communication network. may comprise any appropriate devices for communicating over a wireless communication network. Such devices include mobile telephones, cellular telephones, mobile computers, Personal Digital Assistants (PDAs), radio frequency devices, handheld computers, laptop computers, tablet computers, palmtops, pagers, as well as desktop computers, devices configured as Internet of Things (IoT) devices, integrated devices combining one or more of the preceding devices, and/or the like. As such, the UEs 104 may range widely in terms of capabilities and features. For example, one of the UEs 104 may have a numeric keypad, a capability to display only a few lines of text and be configured to interoperate with only GSM networks. However, another of the UEs 104 (e.g., a smart phone) may have a touch-sensitive screen, a stylus, an embedded GPS receiver, and a relatively high-resolution display, and be configured to interoperate with multiple types of networks. The mobile devices may also include SIM-less devices (i.e., mobile devices that do not contain a functional subscriber identity module (“SIM”)), roaming mobile devices (i.e., mobile devices operating outside of their home access networks), and/or mobile software applications.

In an embodiment, the BS 102 may communicate voice traffic and/or data traffic with one or more of the UEs 104_1, . . . , 104_N. The BS 102 may communicate with the UEs 104_1, . . . , 104_N using one or more appropriate wireless communication protocols or standards. In configurations, the BS 102 may serve as an access point for UEs 104 to access the wireless communication network 100. For example, the BS 102 may be configured as one of many types of networks and thus may communicate with UEs 104 using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like. In a configuration, the wireless communication network 100 may include an IMS network and thus, may provide various services such as, for example, voice over long term evolution (VoLTE) service, video over long term evolution (ViLTE) service and/or rich communication services (RCS).

The BS 102 may be communicatively coupled (e.g., using a backhaul connection, illustrated using solid lines in FIG. 1) to a number of backhaul equipments, e.g., an operation support subsystem (OSS) server 108, a radio network controller (RNC) 110, and/or the like. The RNC 110 can also be in the form of a mobility management entity when the wireless communication network 100 operates according to the long term evolution (LTE) standard or LTE Advanced standard.

In an embodiment, the base station 102 may comprise processors 120, one or more transmit antennas (transmitters) 122, one or more receive antennas (receivers) 124, and computer-readable media 126. The processors 120 may be configured to execute instructions, which may be stored in the computer-readable media 126 or in other computer-readable media accessible to the processors 120. In some embodiments, the processors 120 are a central processing unit (CPU), a graphics processing unit (GPU), or both CPU and GPU, or any other sort of processing unit. The base station 102 can also be in the form of a Node B (where the wireless communication network 100 is 3G UMTS network) or in the form of an eNode B (where the wireless communication network 100 operates according to the LTE standard or LTE Advanced standard).

The one or more transmit antennas 122 may transmit signals to the UEs 104_1, . . . , 104_N, and the one or more receive antennas 124 may receive signals from the UEs 104_1, . . . , 104_N. The antennas 122 and 124 include any appropriate antennas known in the art. For example, antennas 122 and 124 may include radio transmitters and radio receivers that perform the function of transmitting and receiving radio frequency communications. In an embodiment, the antennas 122 and 124 may be included in a transceiver module of the BS 102.

The computer-readable media 126 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the base station 102. The computer-readable media 126 may reside within the base station 102, on one or more storage devices accessible on a local network to the base station 102, on cloud storage accessible via a wide area network to the base station 102, or in any other accessible location.

The computer-readable media 126 may store modules, such as instructions, data stores, and so forth that are configured to execute on the processors 120. For instance, the computer-readable media 126 may store an access point control module 128 and a network settings module 130, as will be discussed in more detail herein later.

Although FIG. 1 illustrates the computer-readable media 126 in the BS 102 storing the access point control module 128 and the network settings module 130, in various other embodiments, the access point control module 128, the network settings module 130, and one or more other modules (not illustrated, may be stored in another component of the network 100 (e.g., other than the BS 102). For example, one or more of these modules may be stored in a computer-readable media included in the OSS server 108, the RNC 110, another appropriate server associated with the network 10, and/or the like.

Although not illustrated in FIG. 1, various other modules (e.g., an operating system module, basic input/output systems (BIOS), etc.) may also be stored in the computer-readable media 126. Furthermore, although not illustrated in FIG. 1, the base station 102 may comprise several other components, e.g., a power bus configured to supply power to various components of the base station 102, one or more interfaces to communicate with various backhaul equipments, and/or the like.

In an embodiment, the UEs 104 may comprise processors 140, one or more transmit antennas (transmitters) 142, one or more receive antennas (receivers) 144, and computer-readable media 146. The processors 140 may be configured to execute instructions, which may be stored in the computer-readable media 146 or in other computer-readable media accessible to the processors 140. In some embodiments, the processors 140 is a central processing unit (CPU), a graphics processing unit (GPU), or both CPU and GPU, or any other sort of processing unit. The one or more transmit antennas 142 may transmit signals to the base station 102, and the one or more receive antennas 144 may receive signals from the base station 12. In an embodiment, the antennas 142 and 144 may be included in a transceiver module of the UE 104.

The computer-readable media 146 may also include CRSM. The CRSM may be any available physical media accessible by a computing device to implement the instructions stored thereon. CRSM may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 104.

The computer-readable media 146 may store several modules, such as instructions, data stores, and so forth that are configured to execute on the processors 140. For instance, the computer-readable media 140 may store a configuration module 148. Although not illustrated in FIG. 1, the computer-readable media 146 may also store one or more applications configured to receive and/or provide voice, data and messages (e.g., short message service (SMS) messages, multi-media message service (MMS) messages, instant messaging (IM) messages, enhanced message service (EMS) messages, etc.) to and/or from another device or component (e.g., the base station 102, other UEs, etc.).

Although not illustrated in FIG. 1, the UEs 104 may also comprise various other components, e.g., a battery, a charging unit, one or more network interfaces, an audio interface, a display, a keypad or keyboard, a GPS receiver and/or other location determination component, and other input and/or output interfaces.

Although FIG. 1 illustrates only one UE (UE 104_1) in detail, each of the UEs 104_2, . . . , 104_N may have a structure that is at least in part similar to that of the UE 104_1. For example, similar to the UE 104_1, each of the UEs 104_2, . . . , 104_N may comprise processors, one or more transmit antennas, one or more receive antennas, and computer-readable media including a configuration module.

In an embodiment, the network settings module 130 stored in the computer-readable media 126 maintains a plurality of network settings associated with the network 100. Individual network settings maintained by the network settings module 130 may be pertinent to a single UE of the UEs 104_1, . . . , 104_N, a subset of the UEs 104_1, . . . , 104_N, or each of the UEs 104_1, . . . , 104_N. For example, a network setting of the plurality of network settings may specify a maximum bit rate at which a UE (or each of the UEs 104_1, . . . , 104_N) may transmit data to the BS 102. Another network setting of the plurality of network settings may specify a transmit time interval (tti) used by each of the UEs 104_1, . . . , 104_N to transmit data to the BS 102. Yet another network setting of the plurality of network settings may specify a maximum power that each of the UEs 104_1, . . . , 104_N may use to transmit data to the BS 102. The plurality of network settings maintained by the network settings module 130 may also include any other appropriate type of network settings.

In an embodiment, one or more of the plurality of network settings maintained by the network settings module 130 may be communicated to the UEs 104_1, . . . 104_N (e.g., by the transmit antennas 122 to the receive antennas 144 of the UEs 104_1, . . . , 104_N). Based on receiving the network settings, the UEs 104_1, . . . , 104_N (e.g., the corresponding configuration modules 148) may configure themselves and communicate with the BS 102 accordingly.

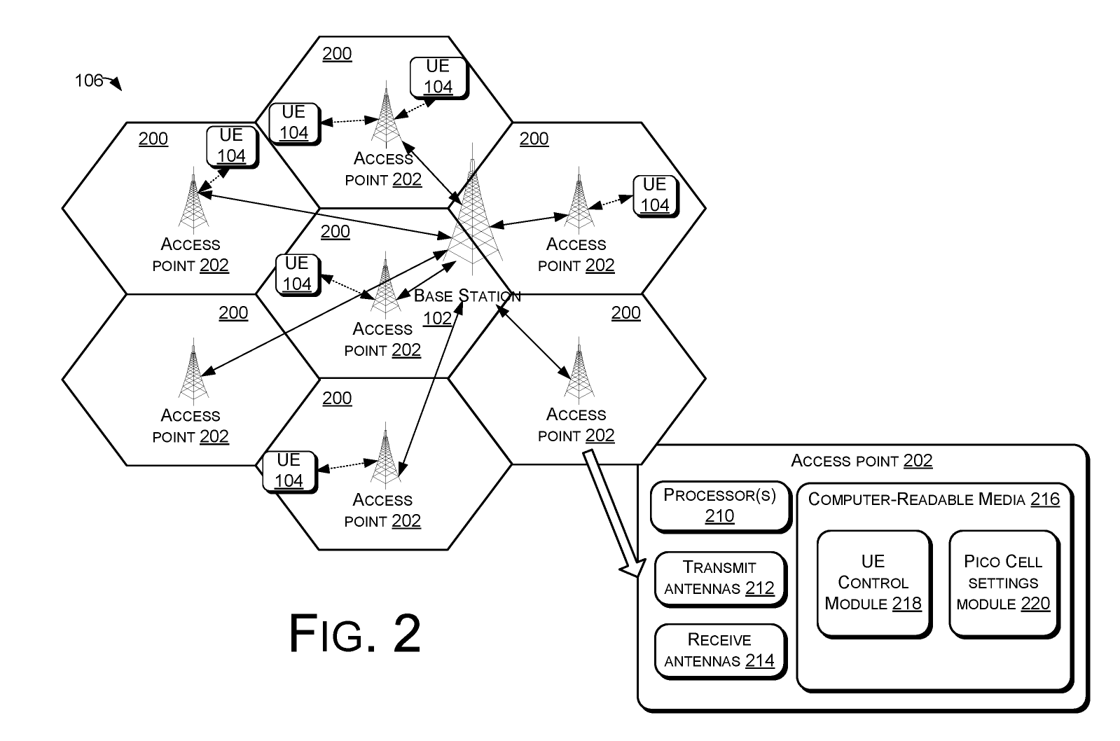

FIG. 2 illustrates the macro cell 106 arranged as a heterogeneous network. The macro cell 106 is divided into a plurality of smaller cells referred to as femtocells, pico cells, micro cells (or the like) 200 (referred to herein as femtocells 200). Each femtocell 200 includes an access point node 202, which is generally a lower power node with respect to the BS 102, which serves as a higher power node for the network 100. Each access point node 202 controls and handles transmission of signals within a corresponding femtocell 200. While the macro cell 106 is illustrated as including six femtocells 200, more or fewer femtocells 200 may be included.

As with the BS 102, in an embodiment, each access point node 202 may communicate voice traffic and/or data traffic with one or more of the UEs 104 that are located within its corresponding femtocell 200. The access point node 202 may communicate with the UEs 104 using one or more appropriate wireless communication protocols or standards. For example, the access point node 202 may communicate with the UEs 104 using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like. In a configuration, as previously noted, the wireless communication network 100 may include an IMS network and thus, may provide various services for the UEs 104 to communicate with the access point node 202 via, for example, voice over long term evolution (VoLTE) service, video over long term evolution (ViLTE) service and/or rich communication services (RCS).

The access point nodes 202 are generally communicatively coupled (e.g., using a backhaul connection, illustrated using solid lines in FIG. 2) to the BS 102. The backhaul connection may include a fiber optic communication channel, a hard wire communication channel, etc.

In an embodiment, the access point nodes 202 may comprise processors 210, one or more transmit antennas 212, one or more receive antennas 214, and computer-readable media 216. The processors 210 may be configured to execute instructions, which may be stored in the computer-readable media 216 or in other computer-readable media accessible to the processors 210. In some embodiments, the processors 210 are a central processing unit (CPU), a graphics processing unit (GPU), or both CPU and GPU, or any other sort of processing unit.

The one or more transmit antennas 212 may transmit signals to the UEs 104, and the one or more receive antennas 214 may receive signals from the UEs 104. The antennas 212 and 214 include any appropriate antennas known in the art. For example, antennas 212 and 214 may include radio transmitters and radio receivers that perform the function of transmitting and receiving radio frequency communications. In an embodiment, the antennas 212 and 214 may be included in a transceiver module of the access point nodes 202.

The computer-readable media 216 for each access point node 202 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the access point node 202. The computer-readable media 216 may reside within the access point node 202, on one or more storage devices accessible on a local network to the access point node 202, on cloud storage accessible via a wide area network to the access point node 202, or in any other accessible location.

The computer-readable media 216 may store modules, such as instructions, data stores, and so forth that are configured to execute on the processors 210. For instance, the computer-readable media 216 may store a UE control module 218 and a femtocell settings module 220, as will be discussed in more detail herein later.

Although not illustrated in FIG. 2, various other modules (e.g., an operating system module, basic input/output systems (BIOS), etc.) may also be stored in the computer-readable media 216. Furthermore, although not illustrated in FIG. 2, each access point node 202 may comprise several other components, e.g., a power bus configured to supply power to various components of the access point node 202, one or more interfaces to communicate with various backhaul equipments, and/or the like.

In an embodiment, the femtocell settings module 220 stored in the computer-readable media 216 maintains a plurality of femtocell settings associated with a corresponding femtocell 200. Individual femtocell settings maintained by the femtocell settings module 220 may be pertinent to a single UE of the UEs 104, a subset of the UEs 104, or each of the UEs 104. For example, a femtocell setting of the plurality of femtocell settings may specify a maximum bit rate at which a UE (or each of the UEs 104) may transmit data to the corresponding access point 200. Another femtocell setting of the plurality of femtocell settings may specify a transmit time interval (tti) used by each of the UEs 104 to transmit data to the corresponding access point 200. Yet another femtocell setting of the plurality of femtocell settings may specify a maximum power that each of the UEs 104 may use to transmit data to the corresponding access point 200. Another femtocell setting may include a frequency or spectrum to sue for transmission and reception of signals within the corresponding femtocell 200, as well as a channel within the spectrum. The plurality of network settings maintained by the femtocell settings module 220 may also include any other appropriate type of femtocell settings.

In an embodiment, one or more of the plurality of femtocell settings maintained by the femtocell settings module 220 may be communicated to the UEs 104 (e.g., by the transmit antenna 212 to the configuration modules 148 of the UEs 104). Based on receiving the femtocell settings, the UEs 104 (e.g., the corresponding configuration modules 148) may configure themselves and communicate with the corresponding access point 200 accordingly.

In an embodiment, the access point control module 128 of the BS 102 controls the access points 200. For example, the access point control module 128 may provide procedures for communicating with the BS 102, procedures for handing off UEs 104 to the BS 102, procedures for handing off UEs among the various femtocells 200 and access point nodes 202, etc. Likewise, the UE control module 218 of the access points controls the UEs 104 within the respective femtocells. For example, the UE control module 218 may provide procedures for communicating with the corresponding access point 200, procedures for handing off UEs 104 to the BS 102, procedures for handing off UEs among the various femtocells 200 and access point nodes 202, etc.

Thus, the wireless communication network 100 of FIGS. 1 and 2 is arranged as a distributed architecture made up of multiple macro cells 106 and femtocells 200. The wireless communication network 100 provides services to a UE 104 that registers with the wireless communication network 100. Services provided within the wireless communication network 100 may include, for example, voice calling services (e.g. telephone calls), Internet access, messaging (e.g., short message service (SMS) messages, multi-media message service (MMS) messages, instant messaging (IM) messages, enhanced message service (EMS) messages, etc.), video services, etc. Such services are generally provided via various nodes of the wireless communication network 100 implemented via servers that UEs 104 access, i.e. the UEs 104 register with the wireless communication network 100 via a node. The nodes also provide various other services within the wireless communication network 100.

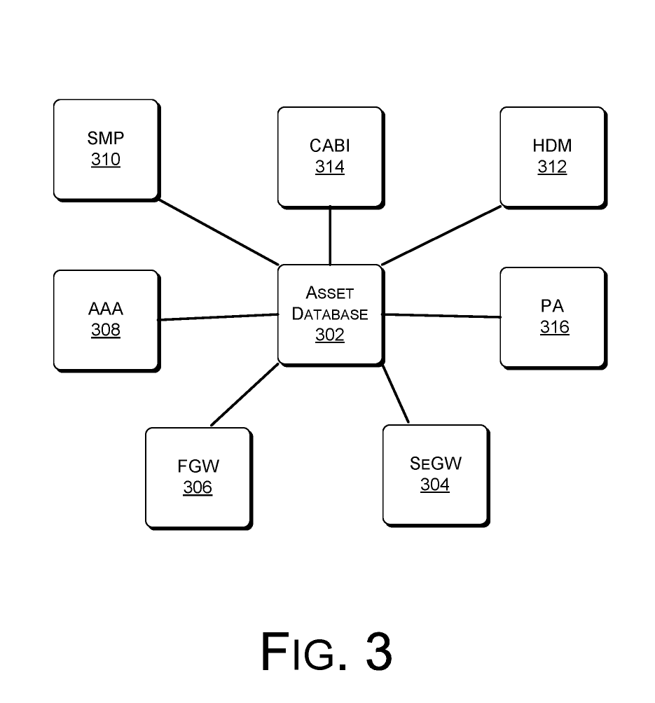

FIG. 3 schematically illustrates an example of various nodes of the wireless communication network 100 operationally coupled to a central database or asset database 302 that provide various services within the wireless communication network 100. The asset database 302 may be located in a data center (not illustrated) of the wireless communication network 100 or other suitable part of the wireless communication network 100. The example nodes include a security gateway node (SeGW) 304, a femtocell gateway/small cell gateway (FGW) 306, an authentication accounting authorization (AAA) node 308, a service management platform node (SMP) node 310, a home device manager (HDM) node 312, a customer account and billing information (CABI) node 314, and a provisioning agent (PA) node 316. The wireless communication network 100 may include more or fewer nodes depending upon the configuration of the wireless communication network 100. Generally, the nodes 304-316, as well as other nodes of the wireless communication network 100, do not share data among themselves.

In a configuration, the wireless communication network 100 may include multiple nodes 304-316. For example, as previously noted, the wireless communication network 100 may be divided into multiple subnetworks and thus, some nodes may be repetitive, e.g., each of the various subnetworks may each include a particular node. Additionally, the wireless communication network 100 is generally divided into multiple macro cells 106 and the macro cells may be divided into femtocells 200. The multiple macro cells 106 and femtocells 200 may be organized into multiple subnetworks that make up the wireless communication network 100. For example, the wireless communication network 100 may be a national network and thus, the wireless communication network 100 may be divided into four regional subnetworks, where each regional subnetwork includes multiple nodes and multiple macro cells 106 that may be divided into femtocells 200. Each of the subnetworks may include one or more of each of a SeGW node 304, a FGW node 306, an AAA node 308, a SMP node 310, a HDM node 312, a CABI node 314, and a PA node 316.

In a configuration, the central database 302 may be coupled to all of the various nodes across the wireless communication network 100, each of the SeGW nodes 304, the FGW nodes 306, the AAA nodes 308, the SMP nodes 310, the HDM nodes 312, the CABI nodes 314, and the PA nodes 316. Since the asset database 302 is operationally coupled to the various nodes, the asset database 302 may pull data from the various nodes by synchronizing with the nodes. The data may be pulled periodically, e.g., in a range of every 30 minutes to one hour. In a configuration, the data may be pulled once a day. The data may relate to various performance and/or service aspects of, for example, the wireless communication network 100, macro cells 106, femto cells 200, the nodes of the wireless communication network 100, etc., as well as other examples of data mentioned herein.

Since the wireless communication network 100 may be divided into subnetworks, the central database 302 may synchronize and pull data from each of the nodes in the subnetworks. In a configuration, each subnetwork may include an instance of the central database 302. An overall central database may then sync the instances of the central database from the subnetworks to synchronize and coordinate all the gathered data of the wireless communication network 100. The central database 302 may organize and synchronize the data pulled based on the node type. For example, the central databased may organize and synchronize the data pulled from each of the SeGW nodes 304 from the subnetworks. Additionally, the central database 302 may normalize the gathered data with respect to at least time since the subnetworks may be located in different time zones.

The SeGW nodes 304 may be located in mobile switch office (MSO) locations of the wireless communication network 100. Thus, in an example where there are four regional subnetworks of the wireless communication network 100, there may be four SeGW nodes 304, one located in the MSO of each regional subnetwork. Generally, the SeGW nodes 304 provide a single point of termination for signaling and user traffic and may thus be referred to as the “gatekeepers” of the wireless communication network 100. Functions of the security gateway include, for example, authentication of a femtocell access point (FAP), and providing access to the operations support system (OSS) and the FGW nodes 306. Data that may be gathered include various errors and system log information. For example, data may be gathered relating to Site Identification (ID), Serial Number, Mobile Station International Subscriber Directory Number (MSISDN), Fair Access Policy (FAP) Status, International Mobile Subscriber Identity (IMSI), International Mobile Equipment Identity (IMEI), RNC ID, Market, Mobile Country Code (MCC), Mobile Network Code (MNC), LTE E-UTRAN Cell Identifier (ECI), UMTS Location Area Codes (LAC), UMTS Cell ID (CID), UTRAN Cell ID (LCID), Latitude, Longitude, Uncertainty, Updated, Pre-provisioning, Activation, LTE Cell ID, Vendor ID, Transaction ID, Requested Action, Customer ID, etc. The list of examples of data is not exhaustive and is not meant to be limiting.

The FGW node 306 generally provides users of the femtocells 200 access to the overall wireless communication network 100. The FGW node 306 generally acts as an access gateway to FAPs and concentrates connections from a large amount of FAPs. An example of data to be gathered includes, for example, content of off-air monitoring (OAM). The FGWs 306 generally are also located in the MSOs of each subnetwork.

The AAA nodes 308 generally provide accounting information with respect to various users of the wireless communication network 100. The AAA nodes 308 may be located in data center locations of the wireless communication network 100. There may be multiple data center locations within the wireless communication network 100, and, in a configuration, each data center location may include two or more AAA nodes 308. Data to be collected may include information relating to accounting logs for the users of the wireless communication network 100.

The SMP node 310 generally provides provisioning and troubleshooting functions for the wireless communication network 100. Generally, the SMP nodes 310 are located in the data centers of the wireless communication network 100 and may have local redundancy as well as geographic redundancy. Data to be collected may include data with respect to identities of users and problems related to service and provisioning of the UEs 104.

The HDM nodes 312 are generally located in data centers of the wireless communication network 100 and may have local redundancy as well as geographical redundancy. The data to be collected may include, for example, identities of users and UEs 104 and FAP data.

The CABI nodes 314 may be located within data centers of the wireless communication network 100. The CABI nodes 314 may provide data relating to customer accounts and billing for various users.

The PA nodes 316 generally receive subscriber data for the UEs 104 and pushes the subscriber data to engineering nodes, including, for example, the SMP nodes 310. Examples of data that may be collected include, for example, data related to the femtocells 200 and connection information to support queries for both the SMP nodes 310 and the HDM nodes 312.

The data collected by the asset database 302 can be synced and organized with respect to the various nodes. The gathered data can also be normalized with respect to at least the various time zones where the nodes may be located. The gathered data may also be normalized in other ways. Based at least in part on the gathered data, asset nodes, e.g., access point nodes 202, may be identified and provisioned and/or activated within small cells 200 of the wireless communication network 100. For example, based upon the gathered data, various issues may be identified and rectified to improve performance of identified asset nodes, as well as to provision and/or activate identified asset nodes.

In configurations, the central database 302 may provide reports related to the gathered data for the various nodes. Additionally, alerts may be generated by the asset database 302 for various problems detected with respect to gathered data related to the various nodes. Additionally, the central database 302 may institute self-healing operations for affected nodes based on the gathered data. Thus, based on the gathered data, audits, reports, alarms, and/or self-healing operations, asset nodes may be provisioned and/or activated. Furthermore, overall health of the wireless communication network 100, and thereby quality of user experience, may be monitored and improved.

Examples of data usage, based on reports and/or alerts, include, activation issues, 911 or emergency call routing problems, device misconfiguration issues, etc. For example, a user may contact customer care of the wireless communication network 100 in order to make changes or configuration steps for the user's UE 104. When the user takes the UE 104 to another macro cell 106 or a different subnetwork of the wireless communication network 100, issues may arise in that the UE 104 may not have been properly configured such that the requested changes do not take effect when the user moves the UE 104. Additionally, the data may allow for proactive audits of the various nodes. Based on such audits, and the findings of the audit, large scale solutions may be deployed across the wireless communication network 100. Such data usage may provide improved performance, as well as provisioning and/or activation of, identified asset nodes.

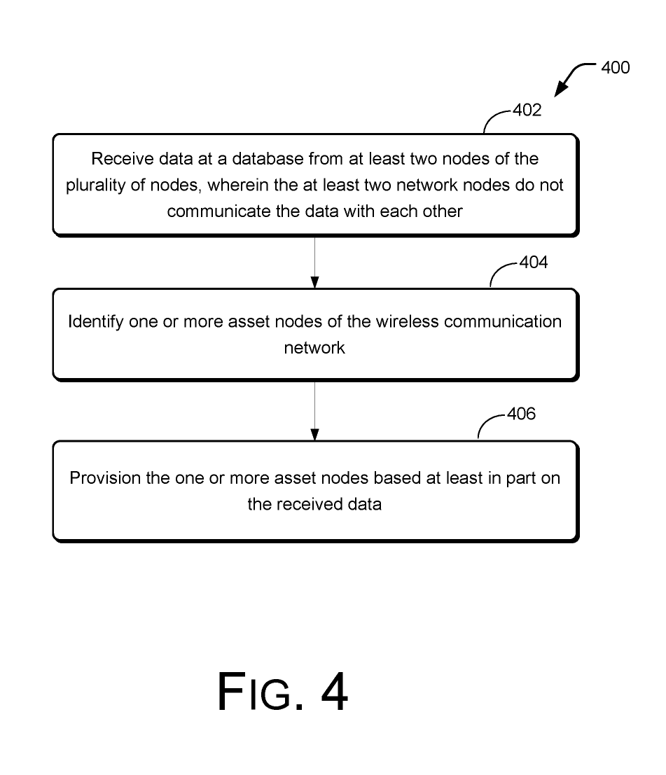

FIG. 4 is a flowchart illustrating a method 400 for gathering data in a wireless communication network, e.g., wireless communication network 100 of FIG. 1, comprising a plurality of nodes arranged in a distributed architecture. As illustrated, at block 402, data is received at a database, e.g., asset database 302, from at least two nodes of the plurality of nodes. The at least two network nodes do not communicate the data with each other. At block 404, one or more asset nodes of the wireless communication network are identified. At block 406, the one or more asset nodes are provisioned based at least in part on the received data.

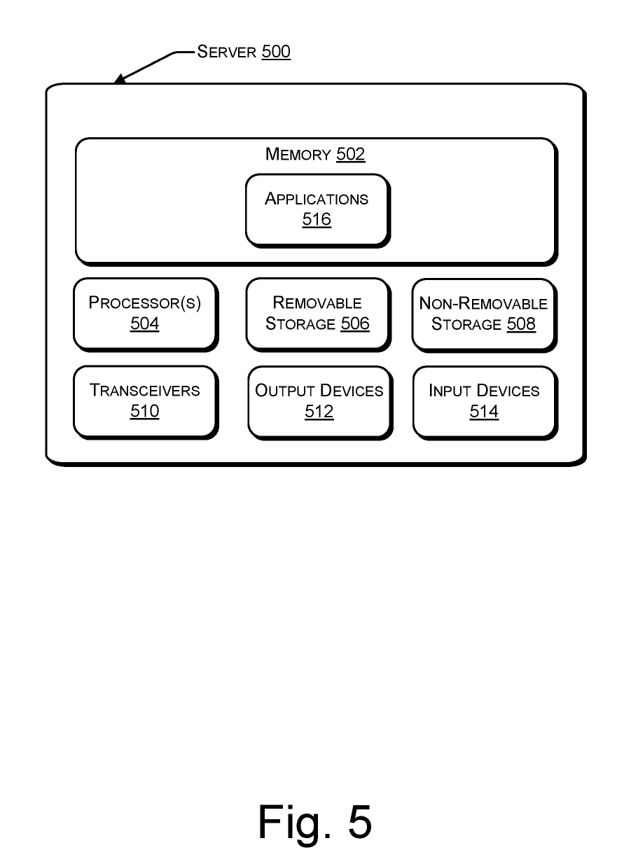

FIG. 5 schematically illustrates a component level view of a server 500 configured for use within a network, e.g., wireless communication network 100, in order to implement various nodes and provide various services within the wireless communication network, according to the techniques described herein. For example, the server 500 may be configured to implement asset database 302 or any of nodes 304, 306, 308, 310, 312, or 314. The server 500 may be located in, for example, the RNC 110 of the wireless communication network 100 or a gateway of the wireless communication network 100. Additionally, the server 500 may be a separate entity located separately from the RNC 110.

As illustrated, the server 500 comprises a system memory 502. Also, the server 500 includes processor(s) 504, a removable storage 506, a non-removable storage 508, transceivers 510, output device(s) 512, and input device(s) 514.

In various implementations, system memory 502 is volatile (such as RAM), non-volatile (such as ROM, flash memory, etc.) or some combination of the two. In some implementations, the processor(s) 504 is a central processing unit (CPU), a graphics processing unit (GPU), or both CPU and GPU, or any other sort of processing unit. System memory 502 may also include applications 516 that allow the server to perform various functions. For example, the applications 516 may allow the server 500 to perform functions described herein with respect to gathering data, organizing and/or normalizing the data and storing the data as described with respect to asset database 302.

The server 500 may also include additional data storage devices (removable and/or non-removable) such as, for example, magnetic disks, optical disks, or tape. Such additional storage is illustrated in FIG. 5 by removable storage 506 and non-removable storage 508.

Non-transitory computer-readable media may include volatile and nonvolatile, removable and non-removable tangible, physical media implemented in technology for storage of information, such as computer readable instructions, data structures, program modules, or other data. System memory 502, removable storage 506 and non-removable storage 508 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 500. Any such non-transitory computer-readable media may be part of the server 500.

In some implementations, the transceivers 510 include any sort of transceivers known in the art. For example, the transceivers 510 may include wired communication components, such as an Ethernet port, for communicating with other networked devices. Also or instead, the transceivers 510 may include wireless modem(s) to may facilitate wireless connectivity with other computing devices. Further, the transceivers 510 may include a radio transceiver that performs the function of transmitting and receiving radio frequency communications via an antenna.

In some implementations, the output devices 512 include any sort of output devices known in the art, such as a display (e.g., a liquid crystal display), speakers, a vibrating mechanism, or a tactile feedback mechanism. Output devices 512 also include ports for one or more peripheral devices, such as headphones, peripheral speakers, or a peripheral display.

In various implementations, input devices 514 include any sort of input devices known in the art. For example, input devices 514 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A computer-implemented method of gathering data in a wireless communication network comprising a plurality of network nodes arranged in a distributed architecture, the computer-implemented method comprising:
receiving data at a database from at least two network nodes of the plurality of network nodes, wherein the at least two network nodes do not communicate the data with each other;
identifying one or more asset nodes of the wireless communication network; and
provisioning the one or more asset nodes based at least in part on the received data.

2. The computer-implemented method of claim 1, further comprising:
periodically syncing of the database with the at least two network nodes of the plurality of nodes,
wherein receiving data at the database from the at least two network nodes of the plurality of network nodes comprises, based at least in part on the syncing, pulling, by the database, the data from the at least two network nodes related to performance of services provided by the at least two network nodes.

3. The computer-implemented method of claim 2, wherein periodically syncing of the database with the at least two network nodes of the plurality of network nodes comprises:
periodically syncing of the database with the at least two network nodes of the plurality of network nodes in a range of every 30 minutes to 1 hour.

4. The computer-implemented method of claim 2, wherein periodically syncing of the database with the at least two network nodes of the plurality of network nodes comprises:
periodically syncing of the database with the at least two network nodes of the plurality of network nodes once a day.

5. The computer-implemented method of claim 1, further comprising:
normalizing the data with respect to at least time.

6. The computer-implemented method of claim 1, further comprising:
based at least in part on the data, performing a self-healing operation at at least one of the at least two network nodes.

7. The computer-implemented method of claim 1, further comprising:
based at least in part on the data, generating an alarm with respect to at least one of the at least two network nodes.

8. The computer-implemented method of claim 1, further comprising:
based at least in part on the data, auditing performance of services with respect to at least one of the at least two network nodes.

9. The computer-implemented method of claim 1, wherein the wireless communication network comprises multiple instances of the database and the computer-implemented method further comprises:
syncing the multiple instances of the database.

10. The computer-implemented method of claim 1, further comprising:
based at least in part on the data, generating a report related to performance of services with respect to at least one of the at least two network nodes.

11. A wireless communication network comprising:
a plurality of network nodes arranged in a distributed architecture;
a database;
one or more processors; and
a non-transitory storage medium including instructions stored in the non-transitory storage medium, the instructions being executable by the one or more processors to:
receive data at the database from at least two network nodes of the plurality of network nodes, wherein the at least two network nodes do not communicate the data with each other;
identify one or more access point nodes of the wireless communication network; and
provision the one or more access point nodes based at least part on the received data.

12. The wireless communication network of claim 11, wherein the instructions are further executable by the one or more processors to:
periodically sync the database with the at least two network nodes of the plurality of network nodes; and
receive data at the database from the at least two network nodes of the plurality of network nodes by, based at least in part on the syncing, pulling the data at the database from the at least two network nodes related to performance of services provided by the at least two network nodes.

13. The wireless communication network of claim 12, wherein the instructions are further executable by the one or more processors to periodically sync the database with the at least two network nodes of the plurality of network nodes in a range of every 30 minutes to 1 hour.

14. The wireless communication network of claim 12, wherein the instructions are further executable by the one or more processors to periodically sync the database with the at least two network nodes of the plurality of network nodes once a day.

15. The wireless communication network of claim 11, wherein the instructions are further executable by the one or more processors to:
normalize the data with respect to at least time.

16. The wireless communication network of claim 11, wherein the instructions are further executable by the one or more processors to:
based at least in part on the data, perform a self-healing operation at at least one of the at least two network nodes.

17. The wireless communication network of claim 11, wherein the instructions are further executable by the one or more processors to:
based at least in part on the data, generate an alarm with respect to at least one of the at least two network nodes.

18. The wireless communication network of claim 11, wherein the wireless communication network comprises multiple instances of the database and the instructions are further executable by the one or more processors to:
sync the multiple instances of the database.

19. The wireless communication network of claim 11, wherein the one or more access point nodes comprise one or more femtocells.

20. The wireless communication network of claim 19, wherein the plurality of network nodes comprises one or more of a security gateway node, a small cell gateway node, an authentication accounting authorization node, a service management platform node, a home device manager node, a customer account and billing information node, and a provisioning agent node.
